(19) United States
(12) Patent Application Publication
(10) Pub. No.: US 2012/0074057 A1
(43) Pub. Date: Mar. 29, 2012

(54) SEPTAGE TREATMENT SYSTEM AND PROCESS

(76) Inventor: James Steven Kovalak, Milan, MI (US)

(21) Appl. No.: 13/207,400

(22) Filed: Aug. 10, 2011

Related U.S. Application Data
(60) Provisional application No. 61/385,848, filed on Sep. 23, 2010.

(51) Int. Cl. C02F 9/14; C02F 1/32; C02F 11/00; C02F 3/02

(52) U.S. Cl. 210/602; 210/151

(57) ABSTRACT

A septage treatment system and process designed to eliminate liquid discharge to groundwater. The system and process use primary treatment, secondary treatment, and tertiary treatment. The tertiary treatment uses a greenhouse system to reclaim septage waste after it has gone through primary and secondary treatment. The greenhouse system fosters ecologically sound usage of septage waste to minimize the environmental impact of septage waste.

### CROSS-REFERENCE TO RELATED APPLICATIONS

This application claims the benefit of U.S. Provisional Application 61/385,848 filed Sep. 23, 2010, which is herein incorporated by reference in its entirety.

### FIELD OF THE INVENTION

The present disclosure is in the technical field of septage treatment. More particularly, the present disclosure focuses on septage treatment systems and processes.

### BACKGROUND OF THE INVENTION

Historically, septage waste has either been trucked to waste water treatment plants (WWTP) or directly applied to farmland.

Trucking waste to a WWTP is undesirable for the following reasons: high trucking costs, high fees from the WWTP, and operational impact on the WWTP because of the high anaerobic load of septage waste.

Direct application of waste to farmland is also undesirable because of the potential contamination of groundwater and regulatory requirements, specifically regulations under the National Pollutant Discharge Elimination System (NPDES).

### BRIEF SUMMARY OF THE INVENTION

The present disclosure describes a septage treatment system and process which comprises: primary septage treatment; secondary septage treatment; and tertiary septage treatment which utilizes a greenhouse to eliminate any discharge to groundwater.

The purpose of primary treatment is to remove solid septage waste prior to secondary treatment. Primary septage treatment comprises: a septage receiving station where trucks or other vehicles unload septage; a receiving tank for the septage, also known as a honey monster; a grit chamber where large solids and sand particles are separated with the use of screens and settling; one or more dumpsters for solids disposal; a mechanical aeration tank where diffused air will be used to reduce Biological Oxygen Demand (BOD), reduce odor potential, and impart dissolved oxygen; and an equalization tank for storage prior to secondary treatment.

In a separate embodiment, pH adjustment occurs after the grit chamber. The pH adjustment raises pH to roughly 10 with NaOH or KOH, to remove metals dissolved in the septage. A flocculating agent, such as a polymer, can be used to aid metals removal. After metals removal, pH is reduced with an acid like HCl or H₂SO₄. Then, the septage goes to the equalization tank in preparation for secondary treatment.

In a separate embodiment, the septage receiving station has sufficient capacity to store all incoming septage during winter months. This enables all septage treatment to occur during summer months, above freezing temperatures.

The purpose of secondary septage treatment is to remove organic waste from the septage through biological action. Secondary septage treatment comprises: watertight vessels which receive septage from the equalization tank, circulate the septage, introduce a biological agent to degrade organic material in the septage, and introduce oxygen to accelerate aerobic biological degradation of the organic material. Without sufficient oxygen, anaerobic degradation occurs and methane is generated (creating the potential for a dangerous explosion). Septage circulation is continuous so that the biological agents can be maintained at a steady state. Ideally, the volume purged from secondary treatment equals the volume added so that a constant volume of material is maintained in secondary treatment. Once a biological agent is added, the septage also becomes known as waste activated sludge (WAS).

Tertiary treatment is the final phase of septage treatment. Tertiary treatment comprises: separating the WAS into a solid component and a liquid component; sending the solid component to a solar drying greenhouse for final dewatering; and sending the liquid component to a multi-step organic treatment sub-system. The multi-step organic treatment sub-system comprises: an aeration step where phytoremediation and evapotranspiration occur; an ultraviolet radiation disinfection step where biological organisms are destroyed; a storage tank for equalization purposes; and a bedding area where plants utilize the remaining liquid component. Hence, no effluent is discharged to ground water or surface water.

In a separate embodiment, the multi-step organic treatment sub-system further comprises a fogging step added after the ultraviolet radiation disinfection step. The fogging step comprises sending the liquid component through a fan, such as an Aquafog™ fan, which is designed to mist the liquid component into micron size droplets. The mist could then be vented to the atmosphere.

In a separate embodiment, the multi-step organic treatment sub-system further comprises a turf watering step added after the ultraviolet radiation disinfection step. The turf watering step comprises using the liquid component to water grass, which consumes and transpires the liquid. The grass could then be harvested as compost.

In a separate embodiment, the multi-step organic treatment sub-system further comprises a fogging step added after the ultraviolet radiation disinfection step and then a turf watering step added after the fogging step.

A centrifuge can be used to separate the WAS into a solid component and a liquid component. Alternately, gravity settling can be used for separation with a clarifier or the like.

The aeration step can be comprised of a zone where shallow open tanks are used with vegetation. The vegetation has a high biological oxygen generation (BOG) capacity.

The bedding area plants can be non-edible.

The solid component of the WAS can be used as biofuel after final dewatering.

The vegetation and sludge that is generated can be harvested and converted into biopellets within the solar drying greenhouse. The dried biopellets can be be used for heating or electricity generation. The vegetation is a bio-crop such as miscanthus or the like. The bio crop would be harvested with a combine-like apparatus. Once the bio-crop is harvested, it can be dried in the greenhouse, pulverized into a dry powder, combined with processed sludge, and turned into biopellets.

In a separate embodiment, the vegetation could be sold in a retail nursery as bedding plants.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 shows a site plan for a septage treatment system.

FIG. 2 is a schematic flow diagram showing the various unit processes and the overall layout of the pilot process.

### DETAILED DESCRIPTION OF THE INVENTION

A septage treatment system and process is needed to treat septage waste locally. The septage treatment system and process would eliminate the need for using a WWTP and also eliminate direct application of the septage waste to farmland.

U.S. Pat. No. 7,553,410 to Chennault describes a septage treatment system and method. Chennault's system and method consists of primary treatment, secondary treatment, and tertiary treatment of the septage waste. The primary treatment includes waste receiving and separation of solids. The secondary treatment includes aerobic treatment combined with biological degradation to create waste activated sludge (WAS). The tertiary treatment includes filtering effluent from secondary treatment through wetland ditches or ponds and then sending the effluent to a greenhouse with an aquaculture capable of creating filtered water effluent which can be discharged to groundwater.

One limitation of Chennault is that NPDES permits are required. Discharge to groundwater could occur with overflow or leaking of the ditches or ponds. Also, discharge to groundwater occurs in the final stage of tertiary treatment.

A second limitation of Chennault is that operation of the system falls under state WWTP regulations because waste is generated which is discharged to the environment. Hence, operators must have state certified WWTP training

What is needed is a holistic approach to septage which turns it into beneficial nutrients instead of treating it as waste. While primary and secondary treatment of the septage would remain similar to Chennault or what occurs in a WWTP, tertiary treatment would use an expanded greenhouse system to reclaim the septage and eliminate any discharge to groundwater.

The septage treatment system and process can be thought of as a series of unit processes, the series comprising: flow monitoring, receiving and influent screening, influent settling, mechanical influent aeration, plant and microbial based aeration, phytoremediation, flow equalization, plant (crop) production, and residuals management.

Flow monitoring: Pilot study design flow is for 500 gallons per day. Flow will be monitored to make sure that the system is not overloaded or underloaded. The flowrate will increase as system capacity increases.

Receiving and influent screening: Incoming septage will be screened through a coarse bar screen to remove bulk solids. Removed solids will be stored in a dumpster and periodically removed to a licensed landfill. When system capacity increases, a self-cleaning mechanical separator will be used to provide efficient and reliable solids removal.

Influent settling: Pilot study capacity is for a 1,500 gallon septic tank to function as a clarifier. Floating and settled solids will be removed at this point.

Mechanical influent aeration: Pilot study capacity is for a 1,500 gallon tank equipped with coarse bubble diffusers. Compressed air will be continuously fed into the tank to reduce odor potential, partially satisfy biological oxygen demand (BOD), and provide dissolved oxygen residual.

Plant and microbial based aeration: Aerobic reactor tanks containing algae are used to digest organic nutrients. The reactor tanks can be open or closed. Open reactor tanks expose the algae to sunlight, stimulating growth. Effluent from the reactor tanks will have solids removed with a separation method such as screening or centrifuging.

Phytoremediation: Hydroponically grown plants provide phytoremediation. The most common plant used is the water hyacinth, which has a filamentous aquatic root system with a high specific area. The roots provide a stable habitat for microbes and biofilm growth. Other plants used include bulrush and the like. Water hyacinth, bulrush, and other like macrophytes sequester heavy metals. The bodies of these plants can be harvested and burned. The heavy metals can be chemically isolated to take them out of the environment.

As the liquid proceeds through each phytoremediation cell, water quality will improve and more diverse plant and animal species will be introduced. Filter feeders such as mussels, snails, and some fish will consume slime, sludge build-up, algae, bacteria, and plankton. Symbiotic relations between different plant and animal species will be explored and adjusted to promote the health and efficiency of the process.

In a separate embodiment, water can be diverted to a separate marsh area with cattails and other marsh plants. Residual water from the marsh area can go to a holding tank and then be used to irrigate a grass area. The grass area has a sand filter with approximately six inches of topsoil, two feet of sand below the topsoil, and a plastic liner below the sand. Residual liquid from the sand filter is then sent to the ultraviolet radiation disinfection step, as discussed in the summary of this disclosure.

Flow equalization: Next, the treated liquid is stored in an equalization tank for periodic testing, controlled application to the final crop, and disinfection (if necessary). If water quality does not meet expectations or if crop requirements dictate, the liquid in the equalization tank will be recycled back to the start of the phytoremediation process.

Plant (crop) production: A container nursery requires 27,000 gallons of water per acre per day. The pilot study plant production area will be about 800 square feet. Plants can be produced for wholesale distribution and for conversion to biofuel.

Residuals management: All solids removed from the incoming septage will be hauled to a licensed landfill for disposal. Any excess solids and liquids generated will be hauled to an approved septage receiving station. Crops and crop residuals can be sold, composted, or processed and used as biomass for biofuel.

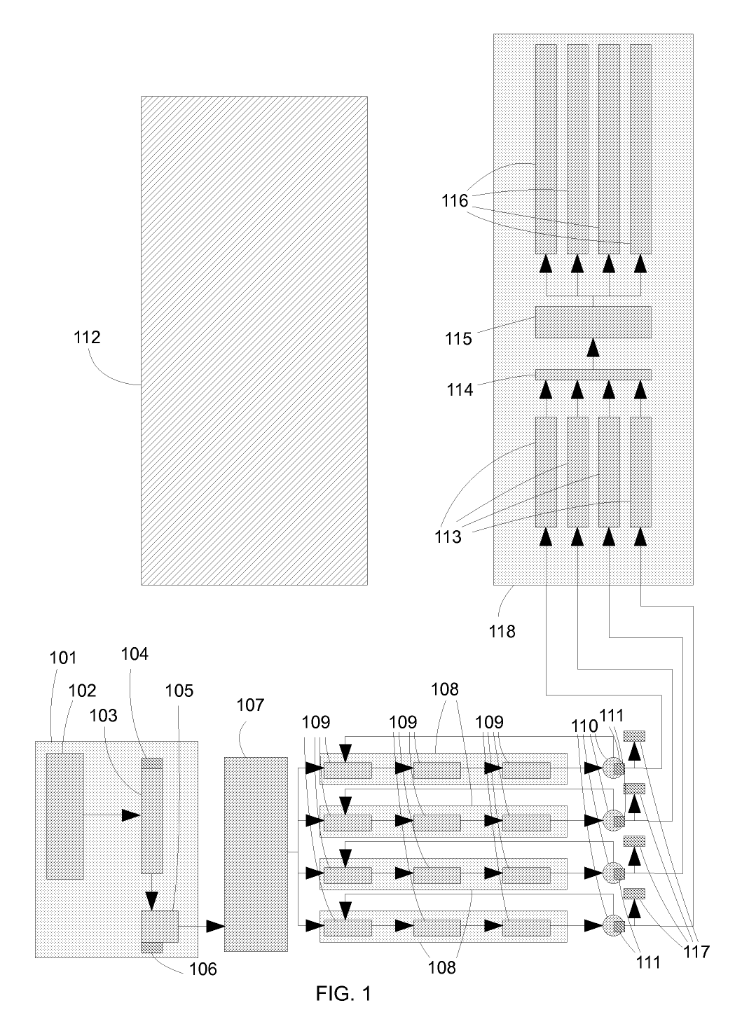

FIG. 1 shows a site plan for a septage treatment system. Septage arrives at a receiving station 101 via truck 102. The septage is pumped from the truck 102 to a honey monster 103. A primary dumpster 104 is for an waste solids that are immediately separable. From the honey monster 103, the septage goes through a grit chamber 105 which removes coarse solids. The coarse solids are placed in a secondary dumpster 106. After the grit chamber 105, the septage goes to an equalization tank 107 in preparation for secondary treatment. From the equalization tank 107, the septage is divided into a watertight septic tank groups 108. There are four watertight septic tank groups 108 with three watertight septic tanks 109 in each group. For each group of water tight septic tanks 108, there is an aerobic treatment unit 110 which vigorously mixes air or oxygen into the septage and recirculates it within the respective water tight septage tank group 108. For each water tight septage tank group 108, an air lift pump 111 purges septage to tertiary septage treatment. Prior to tertiary treatment, the septage is separated into liquid and solid phases. The separation can occur with gravity settling such as in a clarifier or settling chamber (not shown), or mechanically such as with a centrifuge (not shown). The solid phase septage is temporarily placed in staging areas 117 before going to a solar drying greenhouse 112. The liquid septage phase goes to an aerated zone 113 where phytoremediation and evapotranspiration occur. After the aerated zone 113, there is a an ultraviolet radiation disinfection 114 step. Next, the liquid septage phase goes into a storage tank 115. Finally, the liquid septage phase is equally dispersed across an area with non-edible bedding plants 116. The aerated zone 113, ultraviolet radiation disinfection 114, storage tank 115, and non-edible bedding plants 116 are located on a concrete pad 118.

Note that the non-edible bedding plants 116 can be sold in a retail nursery or harvested. If the non-edible bedding plants 116 are harvested, a combine-like apparatus is used for harvesting. Then the non-edible bedding plants 116 are dried in the greenhouse, pulverized into a dry powder, combined with processed sludge, and turned into biopellets.

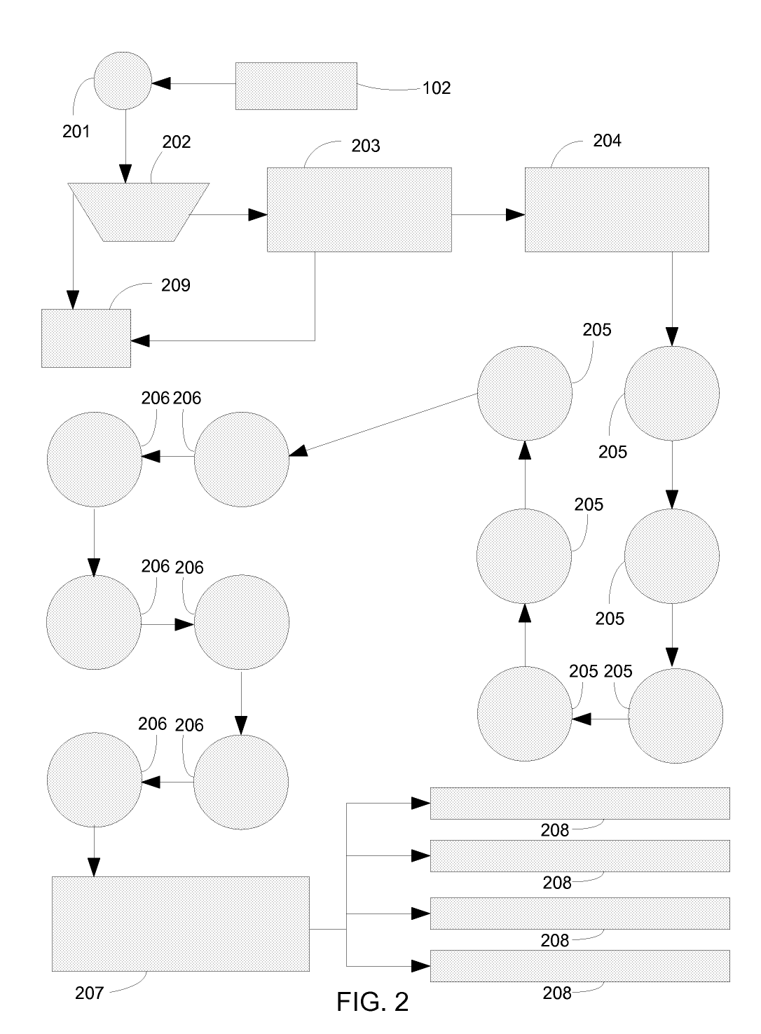

FIG. 2 is a schematic flow diagram showing the various unit processes and the overall layout of the pilot process. A truck 102 brings septage to the flow monitoring unit 201. From there, septage flows to receiving and influent screening 202. Screened solids are sent to a dumpster for residuals management 209. The liquid portion of the septage goes to the influent settling stage 203. From there, liquid goes to mechanical influent aeration 204. Then, liquid goes to plant and microbial based aeration 205. Then, liquid goes to phytoremediation 206. Then, liquid goes to flow equalization 207. Finally, liquid goes to plant (crop) production 208.

The septage treatment process can also be described in steps. One embodiment of the process is given in the steps below.

Step 1: the trucks arrive and directly discharge their septage loads into a screening machine.

Step 2: in the screening machine, bulk solids become separated from the septage and compacted. The compacted bulk solids are discarded into a dumpster.

Step 3: the septage leaves the first screening machine and travels into a grit screening machine. This further separates finer particles of dirt and sand from the septage. The particles of sand and dirt will be put into a dumpster.

Step 4: the septage goes through aeration chambers. The chambers mix oxygen into the septage, causing further particle breakdown.

Step 5: the septage will then go through settling chambers where heavier organic particles naturally settle to the bottom of the chambers. The settled particles become sludge. Sludge will be manually removed from the chambers.

Step 6: the septage goes through a solar aquatic treatment system.

Step 7: the solar aquatic treatment system uses aerators and plants to further clean the liquid septage, converting it to water.

Step 8: The water goes through an ultraviolet sterilization chamber to kill any living organisms.

Step 8a: In a separate embodiment, the water goes through a fan, such as an Aquafog™ fan, which is designed to mist the liquid component into micron size droplets. The mist could then be vented to the atmosphere.

Step 8b: In a separate embodiment, the water is sprinkled onto grass, which consumes and transpires the liquid. The grass could then be harvested as compost.

Step 9: The sterilized water can now be used for irrigation.

Step 10: Additional aquatic plant life growing throughout the greenhouse complex is irrigated with the sterilized water.

Step 11: Aquatic plants are mechanically harvested by a combine-like machine on a track. This machine is suspended overhead removes the aquatic plants for further harvesting.

Step 12: Further processing occurs in drying greenhouses, where the aquatic plants are dehydrated.

Step 13: Aquatic plant life and other plant life growing throughout the complex will be combined and broken down by a hammer mill/shredder.

Step 14: This plant material will then be combined in a pug mill/mixing unit with the sludge (resulting from Step 5) in a ratio of approximately 90% plant to 10% sludge.

Step 15: The combined mixture will then be put into a pellet mill to produce biopellets.

Step 16: Slow moving conveyor belts will be used in drying greenhouses to help further dry the biopellets.

Step 17: The biopellets can then be used for heating or energy production.

For the purposes of this disclosure, septage is defined as waste obtained from septic tanks, liquid sanitary waste material, medical waste material, food waste, commercial farm animal waste, reclaimed paper, and the like.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

I claim:

1. A system for treating septage, the system comprising:
A) primary septage treatment comprising:
a septage receiving station where vehicles unload septage;
a receiving tank for the septage;
a grit chamber where large solids and sand particles are separated with the use of screens and settling;
one or more dumpsters for solids disposal;
a mechanical aeration tank where diffused air will be used to reduce Biological Oxygen Demand (BOD), reduce odor potential, and impart dissolved oxygen; and
an equalization tank for storage prior to secondary treatment;
B) secondary septage treatment with watertight vessels, the secondary treatment comprising:
means to receive septage from the equalization tank;
means to circulate the septage;
means to introduce a biological agent to degrade organic material in the septage; and
means to introduce oxygen to accelerate aerobic biological degradation of the organic material; and
C) tertiary septage treatment which utilizes a greenhouse to eliminate any discharge to groundwater, the tertiary treatment comprising:
means to separate the septage into a solid component and a liquid component;
means to send the solid component to a solar drying greenhouse for final dewatering; and
means to send the liquid component to a multi-step organic treatment sub-system, the multi-step organic treatment sub-system comprising:
means to provide an aeration step where phytoremediation and evapotranspiration occur;
means to provide an ultraviolet radiation disinfection step where biological organisms are destroyed;
means to provide a storage tank step for equalization purposes; and
means to provide a bedding area step where plants utilize the remaining liquid component.

2. The system of claim 1, wherein the system further comprises means to provide a fogging step added after the ultraviolet radiation disinfection step.

3. The system of claim 1, wherein the system further comprises means to provide a turf watering step added after the ultraviolet radiation disinfection step.

4. The system of claim 1, wherein the system further comprises means to provide a fogging step added after the ultraviolet radiation disinfection step and then a turf watering step added after the fogging step.

5. A process for treating septage, the process comprising:
A) performing primary septage treatment comprising:
providing a septage receiving station where vehicles unload septage;
providing a receiving tank for the septage;
providing a grit chamber where large solids and sand particles are separated with the use of screens and settling;
providing one or more dumpsters for solids disposal;
providing a mechanical aeration tank where diffused air will be used to reduce Biological Oxygen Demand (BOD), reduce odor potential, and impart dissolved oxygen; and
providing an equalization tank for storage prior to secondary treatment;
B) performing secondary septage treatment with watertight vessels, the secondary treatment performance comprising:
receiving septage from the equalization tank;
circulating the septage;
introducing a biological agent to degrade organic material in the septage; and
introducing oxygen to accelerate aerobic biological degradation of the organic material; and
C) performing tertiary septage treatment which utilizes a greenhouse to eliminate any discharge to groundwater, the tertiary treatment performance comprising:
separating the septage into a solid component and a liquid component;
sending the solid component to a solar drying greenhouse for final dewatering; and
sending the liquid component to a multi-step organic treatment sub-system, the multi-step organic treatment sub-system comprising:
providing an aeration step where phytoremediation and evapotranspiration occur;
providing an ultraviolet radiation disinfection step where biological organisms are destroyed;
providing a storage tank step for equalization purposes; and
providing a bedding area step where plants utilize the remaining liquid component.

6. The process of claim 5, wherein the process further comprises providing a fogging step added after the ultraviolet radiation disinfection step.

7. The process of claim 5, wherein the process further comprises providing a turf watering step added after the ultraviolet radiation disinfection step.

8. The process of claim 5, wherein the process further comprises providing a fogging step added after the ultraviolet radiation disinfection step and then a turf watering step added after the fogging step.
